(19) United States
(12) Patent Application Publication
(10) Pub. No.: US 2007/0130343 A1
(43) Pub. Date: Jun. 7, 2007

(54) Means and method for generating a unique user's identity for use between different domains

(76) Inventors: Avelina Pardo-Blazquez, Madrid (ES); Miguel Carretero Gomez, Madrid (ES); John Michael Walker, Madrid (ES); Miguel-Angel Monjas-Llorente, Madrid (ES); Jesus-Angel de-Gregorio-Rodriguez, Madrid (ES)

Correspondence Address: ERICSSON INC., 6300 LEGACY DRIVE, M/S EVR 1-C-11, PLANO, TX, 75024, US

(21) Appl. No.: 10/595,247

(22) PCT Filed: Sep. 30, 2003
(86) PCT No.: PCT/SE03/01518

§ 371 Date: Feb. 22, 2007

(51) Int. Cl. G06F 15/16

(52) U.S. Cl. 709/227

(57) ABSTRACT

Mobile operators presently offer services on behalf of service providers where such services are really carried out for the users. Mobile operators act as identity providers in this scenario, wherein service provider and identity provider share a unique identity to identify each particular user accessing a number of services. As the number of users accessing these services, and the number of services offered from different service providers increase, the storage required at the operator's network for such amount of user's identities becomes a problem. To overcome this and other problems, the present invention provides an identity Generator device arranged to generate a user's service indicator to identify the user between the service provider and the identity provider, the user's service indicator comprising a master user's identifier for identification of the user at the identity provider, and a service identifier indicating the services to be accessed at a given service provider.

### FIELD OF THE INVENTION

The present invention generally relates to the generation of unique user identities for identification of users between different domains, on permanent or temporary basis, that are opaque and cannot be understood by third parties. More particularly, the invention pertains to means and methods for handling a plurality of user identities that a user may have under different service providers, while reducing the number of user searching keys and required storage.

### BACKGROUND

Mobile operators have realised presently that they need to offer a wide and attractive range of services to their users in order to enable the takeoff of the mobile. Internet. In the beginning, the operators thought that they were able to develop, host, and offer all those services. This approach has proven inappropriate for the expected takeoff and mobile operators have changed their mind. Now, operators seek to provide access to attractive services independently of where these services are provided.

Services may be own, even if just on a small fraction, or provided by partner service providers hosting and developing services that are integrated within an operators' service offer, or provided by a so-called federation of service providers, namely service providers that have reached an agreement with operators in order to accept the authentication of users performed by said operators. To sum up, the variety of relationships between a mobile operator and a service provider is infinite.

Different scenarios may turn up from a scenario where mobile operators offer services on behalf of service providers to another scenario where service providers offer services on their own whilst having a sort of agreement with mobile operators. In all these possible scenarios, user's identity-related issues are a key aspect that has to be handled very carefully, especially, in respect of the privacy and data protection.

For instance, a so-called Identity Federation is a protocol used by the Liberty Alliance Project whereby user's identities given at two different domains are federated. In this context, the term “federated” may be understood as “linked”, “coupled”, “associated”, etc. Thus, an identity Federation occurs between an Identity Provider (IDP), which is generally responsible for authenticating a user and maintaining user's identities and user's identifiers, and a Service Provider (SP) at which the user has an account. Generally speaking, an Identity Provider (IDP) establishes a business relationship with a group of Service Providers (SP) for Identity Federation purposes, amongst others.

Both actors, namely the IDP and the SP, may refer to an end-user by using other respective identities such as handles, aliases, pseudonyms or references understood by both. However, the identity currently used between both actors to refer to said end-user is a new identity only understood by the involved parties, and unintelligible to any third actor. Thus, the user's real identity at either domain is never exchanged between them; instead an alias is used, where alias is a sort of pseudonym, handle, reference, penname, etc. and wherein each domain is able to map the alias into a user's local identity for identification purposes. In this respect, the term “identity” is understood in a broad sense to refer any identifier or indicator that my represent or address an entity or user. In other words, the Identity Provider (IDP) is arranged to map each user's alias into its identity at the IDP, and a similar behaviour applies to the Service Provider (SP). The advantage of using aliases, as described above, is that security and privacy threats are somewhat minimised when different domains need refer to an end-user, since a third party is not able to guess the real identity of the user from the alias used between the IDP and the SP.

The use of aliases as means to refer to an end-user while hiding their real identity might be required also in scenarios other than Liberty Alliance. For instance, the European Union has two directives, 97/66/CE and 95/46/CE, respectively concerning privacy in telecommunications and data protection.

As already commented above, different scenarios may turn up and, in particular, an Identity Provider (IDP) for a user may be a mobile operator wherein the user data are accessible. For instance, there might be one scenario where the operator includes services from other Service Providers in its portfolio. This scenario may represent the operator as a sort of Virtual Service Provider, since the operator virtually offers services. A subscription relationship is established between the operator, namely the Virtual Service Provider (hereinafter VSP), and its user. The operator, in order to offer services to said user, signs agreements with external service providers, so that they actually offer the services on behalf of the operator.

Regarding the way a service handles its users at a Service Provider, there are two basic situations: services with a user account and services without a user account, wherein the former has been introduced above and both, former and latter, are further exemplary commented.

On the one hand, an example of services with a user account might be a stock quotes alarm service, wherein a user receives a short message (generally known as Short Message Service and abbreviated as “SMS”) every time Ericsson stocks reaches a stop loss. The service, offered by ACME Stock Alarms Inc. and subscribed through the user's mobile operator, needs to keep a user's account in order to keep user's preferences, for instance the name of the stock and the value of the stop loss. Besides, ACME Stock Alarms Inc. and the mobile operator both need to share a user's identity, namely an identity used by the user to access the service in order to customise it and, at the same time, an identity that ACME Stock Alarms Inc. uses to indicate the operator the destination of the short message.

A method conventionally followed comprises a first step wherein the service provider and the mobile operator reach an agreement. A usual agreement might include single Sign On (SSO) functionality by virtue of which a user does not have to authenticate towards the service; instead, the operator handles the authentication and let the user access transparently to the service and to some operator's capabilities, such as accessing to messaging capabilities.

In a second step of this method the user subscribes a service from the operator's portfolio, which in the present example might be the Stock Quotes Alarm service provided by ACME Stock Alarms Inc.

In a third step of this method the operator, particularly acting as an Identity Provider, generates a user's identity and delivers it to the service. This identity shall be opaque and used by the service to create its own user account. There is currently no standard procedure for provisioning a user from an operator to a service hosted by an external service provider. Only Liberty Alliance has standardized the above Identity Federation mechanism to link pre-existent user accounts between a Service Provider (SP) and an Identity Provider (IDP), the latter being the operator in particular, though this mechanism is not applicable here since no previous account at the service is available.

In a fourth step of this method and for the example above, the user accesses the service to personalise the service settings and preferences by means of a WAP browser, for instance. The operator may provide some kind of SSO functionality so that the user does not have to authenticate towards the exemplary Stock Quotes Alarm service. Instead, the operator handles the authentication and delivers the previously agreed identity to the service.

In further steps of this method, once the service is customised, the service can make use of said user's identity to access the operator's domain, for instance, to access the messaging system in order to send an SMS. The operator will then have to find out the identity of the user at the internal enabler, a Short Message Service Centre (SMSC) in the present example, from the given user's identity shared by the operator and the service provider. This information is typically stored in an operator's user directory, so that the operator uses the given user's identity as the argument to perform a search operation in said user directory.

This leads to a huge amount of identities to be used as arguments for search operations per each user, given that different user's identities are used per service provider, and even per service at a service provider.

On the other hand, an example of service without a user account might be a download service for ring melodies, wherein a user sends an SMS to an ACME Hard Downloads service requesting the download of a specific ring melody. Once the request has been processed, the service sends another SMS to the user. Other possibility could be that the user accesses the service by means of a WAP phone through an operator's main page, and requests such ring melody. In any of these examples, no previous subscription to the service is needed. However, the operator has to deliver a user's identity to the service in order to let it send back a logo through operator's messaging capabilities.

A method conventionally followed to offer services without a user account comprises a first step wherein a service provider and a mobile operator reach an agreement. A usual agreement includes functionality for delivery of a user's identity, that is, the user does not have to provide any identity to the service; instead, the operator let the user access transparently to the service while providing an individual identity to the service provider. The agreement generally includes access to some operator's capabilities, which in the above example might be an access to messaging capabilities.

In a second step of this method the operator advertises the service so that users are aware of it.

Then, in a third step of this method and for the above example, the user accesses the service, either via SMS or WAP, and requests a specific melody.

In a fourth step of this method the operator creates a temporary user's identity and delivers it to the service. This temporary user's identity may be a subscriber directory number as the one generally known as an A-number or subscriber directory number. This temporary user's identity is opaque and just used by the service to send back the contents requested by the user.

Once the user's request has been processed, there is a further step wherein the service makes use of the temporary user's identity to access the operator's domain, that is, to access the messaging system in order to send an SMS and to complete the download.

Presently, and generally speaking, there is a number of challenges aiming the present invention to overcome the mostly common and some particular drawbacks from these two approaches.

A first drawback to deal with is that a single operator's user typically has a large number of identities at both network operator and service providers, and in most of the cases a user has an identity per each subscribed service. In this respect, temporary and permanent user's identities in each service namespace have to be unique in order to let each service have a key to create accounts. Moreover, two different users cannot have the same identity, either temporary or permanent, for the same or different services in order to let the operator connect the identity to the actual user it belongs to. Furthermore, identities for a same user must be different in order to prevent external service providers to create some kind of user profile by linking data from different services. Thus, there is a huge number of user's identities and identifiers to be stored in a user directory accessible to the network operator acting as Identity Provider. As the number of subscribers grow and the use of services increases, the huge number of user's identities and identifiers to be stored in a user directory becomes a problem for the operators in this sort of scenarios.

A second drawback is that, currently, some knowledge about the actual end-user's identity in the real world can be extracted from the user's identity in the telecommunication world. In this respect, both temporary and permanent users' identities have to be opaque for the services. This feature is usually due to regulatory and privacy constraints. Thereby, the handling of user's identities by the operators requires a large number of indices, what introduces big performance penalties and is also a problem addressed by the present invention. Even if a unique alias is used between the Identity Provider (IDP) and the Service Provider (SP), as the alias is the sole identity referring to an end-user in all communications between two actors such as service providers and identity providers, the alias can be considered a primary key for searching in their respective databases for said user's profile. Administration and storage of aliases or pseudonyms in databases at each actor, especially at the identity provider, which in particular might be an operator, would be difficult once the number of aliases per user increases above a certain threshold value. This fact also has a negative impact on the performance of database operations, especially search or lookup operations.

On the other hand, another challenge of the invention is the protection of users from malicious Service Providers that create services delivering contents to the users without having been requested. As these services are usually premium ones, this misbehaviour let those Service Providers get revenues for non-requested contents. As a consequence, further challenges turn up over the ones mentioned above in respect of handling the user's identity management and services without a user account.

A first additional challenge is that a service should not be able to “guess” valid temporal identities in order to prevent malicious services from delivering contents, which had not been requested, by using a “guessed” temporal identity. Another additional challenge is that a temporary identity must have a limited lifetime in order to prevent malicious services from delivering contents that had not been requested by using an old temporary identity. A further additional challenge is the provision of a simpler method to verify whether a temporary identity is still valid. Moreover, these challenges must be accomplished in a manner that the impacts on the operator's database systems are minimised.

Thereby, an important object of the present invention is the provision of means and methods to overcome and fit the above drawbacks and challenges respectively.

It is a further object of the present invention to achieve a suitable solution that still minimizes the impacts on the operator's user directory systems.

### SUMMARY OF THE INVENTION

The above objects, among other things, are accomplished in accordance with the invention by the provision of means and method for generating a user's service indicator for a user to access a number of services offered by a service provider through a network operator where user data for the user are accessible.

Therefore, these means are provided in a specific device, which is called Identity Generator device in this specification, arranged for generating a user's service indicator, this user's service indicator being usable between the service provider domain and the identity provider domain, the latter being in particular a network operator domain, in order to unambiguously identify the user at each respective domain.

The Identity Generator device, in accordance with the invention, comprises:
means for obtaining a master user's identifier usable to identify the user at the operator's network;
means for obtaining a service identifier, indicative of services to be accessed at the service provider; and
means for constructing a user's service indicator that includes the master user's identifier and the service identifier.

In particular, the above master user's identifier might be built up as function of a real user identity.

This Identity Generator device may be preferably adapted in such manner that the service identifier, which is indicative of services to be accessed at the service provider, comprises at least one element selected from: a service provider indicator, and a number of service indicators.

Moreover, this Identity Generator device may further comprise:
means for obtaining at least one element selected from: network operator identifier, auxiliary value, expiry time, and integrity code; and
means for including the at least one element into the user's service indicator.

The Identity Generator device may further comprise means for carrying out a reverse identity generation to obtain the master user's identifier from the user's service indicator, though this means for carrying out a reverse identity generation might as well reside in another entity such as a Border Gateway placed at the border of the operator domain for verification purposes, amongst others.

This Identity Generator device may advantageously comprise means for carrying out a symmetric cipher of the user's service indicator using a ciphering key. In this respect, different advantages further explained might be obtained by having a unique ciphering key for all the applicable service providers, or a different ciphering key per each service provider. In the case of having a different ciphering key per each service provider, the Identity Generator device, or rather the means for carrying out a reverse identity generation, also comprises means for determining the service provider having issued a communication based on a given user's service indicator, so that the appropriate ciphering key is used.

The Identity Generator device, in accordance with the invention, can be integrated in, or in close co-operation with, an entity of an identity provider network. In particular, this identity provider network may be an operator's network where the user data are accessible, or the user's home network.

In this respect, the Identity Generator device may be integrated in, or in close co-operation with, a Central Provisioning Entity responsible for provisioning tasks in the operator's network, or a user Directory System storing user data, or a Border Gateway placed at the border of the operator domain. Also in particular, this Border Gateway may be an entity selected from: an HTTP Proxy, a WAP Gateway, and a Messaging Gateway.

Complementarily to the Identity Generator device, there is provided a Decomposer component having the above means for carrying out a reverse identity generation, the Decomposer component arranged for integration in, or co-operation with, at least one entity selected from: the Identity Generator device, and other entities at the identity provider domain or at the service provider domain. In particular, on of these other entities might be a Border Gateway selected from: an HTTP Proxy, a WAP Gateway, and a Messaging Gateway.

In this respect, provided that a basic structure without encryption was used to generate a given user's service indicator, and that the Decomposer component is not aware of this structure, the means for carrying out a reverse generation in this Decomposer component includes means for obtaining the service identifier used to generate said given user's service indicator.

Provided that other identifiers, auxiliary values, or ciphering mechanism had been used to generate a given user's service indicator, the means for carrying out a reverse generation in this Decomposer component may further include means for obtaining at least one element selected from: network operator identifier, and ciphering key used to generate the given user's service indicator.

In addition, and preferably for verification of a given temporary user's service indicator, the means for carrying out a reverse generation at this Decomposer component may further include:
means for obtaining applicable expiry time criteria; and
means for verifying the validity of a given temporary user's service indicator (T-USI) against said expiry time criteria.

More generally speaking, the Decomposer component further comprises means for verifying the validity of a given user's service indicator, temporary or not, by making use of the master user's identifier as a search key towards a user directory system.

A method is also proposed by the present invention for generating a user's service indicator that is intended for a user to access a number of services offered by a service provider through a network operator where user data for the user are accessible, this user's service indicator being usable between the service provider domain and an identity provider domain, the latter being in particular a network operator domain, to unambiguously identify the user at each respective domain.

The method, in accordance with the invention, comprises:
a step of obtaining a master user's identifier usable to identify the user at the operator's network;
a step of obtaining a service identifier, which is indicative of services to be accessed at the service provider; and
a step of constructing a user's service indicator that includes the master user's identifier and the service identifier.

In particular, the step of obtaining a master user's identifier may include a step of applying a function to a real user identity in order to hide said real user identity.

The method may be preferably adapted in such manner that the step of obtaining a service identifier may include a step of obtaining at least one element selected from: a service provider indicator, and a number of service indicators.

The method may also preferably comprise:
a step of obtaining at least one element selected from: network operator identifier, auxiliary value, expiry time, and integrity code; and
a step of including the at least one element into the user's service indicator.

The method may further comprise a step of carrying out a reverse generation to obtain the master user's identifier from the user's service indicator.

The method may advantageously comprise a step of carrying out a symmetric cipher of the user's service indicator using a ciphering key. The ciphering key may be unique for all the applicable service providers, or be different per each service provider. In the case of having a different ciphering key per each service provider, the method also comprises a step of determining the service provider having issued a communication based on a given user's service indicator, so that the appropriate ciphering key is used.

### BRIEF DESCRIPTION OF DRAWINGS

The features, objects and advantages of the invention will become apparent by reading this description in conjunction with the accompanying drawings, in which:

FIG. 1 basically represents a scenario where a user get access through a network operator to services offered at different service providers, the user being identified by a specific user's identity at each service provider, and the operator's network holding a particular user's searching key per each service provider at its user directory system, in addition to the one or several user's identity at the operator's network.

FIG. 2 shows a simplified view of an Identity Generator device arranged for a direct generation of a user's service indicator as a function of a master user's identifier and a particular service provider, as well as for a reverse generation of a master user's identifier as a reverse function of the user's service indicator and the particular service provider.

FIG. 3A and FIG. 3B show the basic actors in a scenario wherein the present invention applies; FIG. 3A illustrating the provision of a user's alias identity from the Identity Provider to the Service Provider, and FIG. 3B illustrating the use of said user's alias identity from the Service Provider to the Identity Provider.

FIG. 4 shows an exemplary generation of a user's service indicator for a user to access a number of services offered by a service provider through a network operator, in accordance with an embodiment of the invention.

FIG. 5 illustrates an exemplary generation of a user's Temporary service indicator for a user to temporary access a number of services offered by a service provider through a network operator, in accordance with another embodiment of the invention.

### DETAILED DESCRIPTION OF PREFERRED EMBODIMENTS

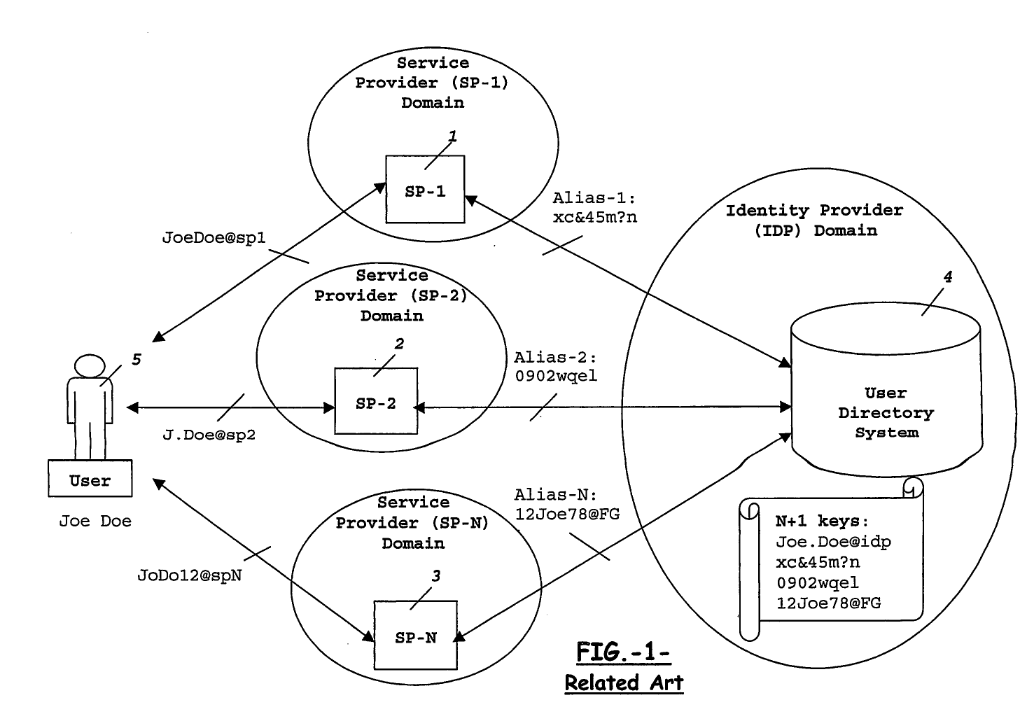

The following describes currently preferred embodiments of means, and methods for a user (5) to access a number of services offered by a service provider (SP-1; SP-2; SP-N) through an identity provider (IDP) with a unique user's alias (Alias-1; Alias-2; Alias-N) shared by the service provider and the identity provider. In particular, the identity provider is a network operator where the user data (4) are accessible, as illustrated in FIG. 1.

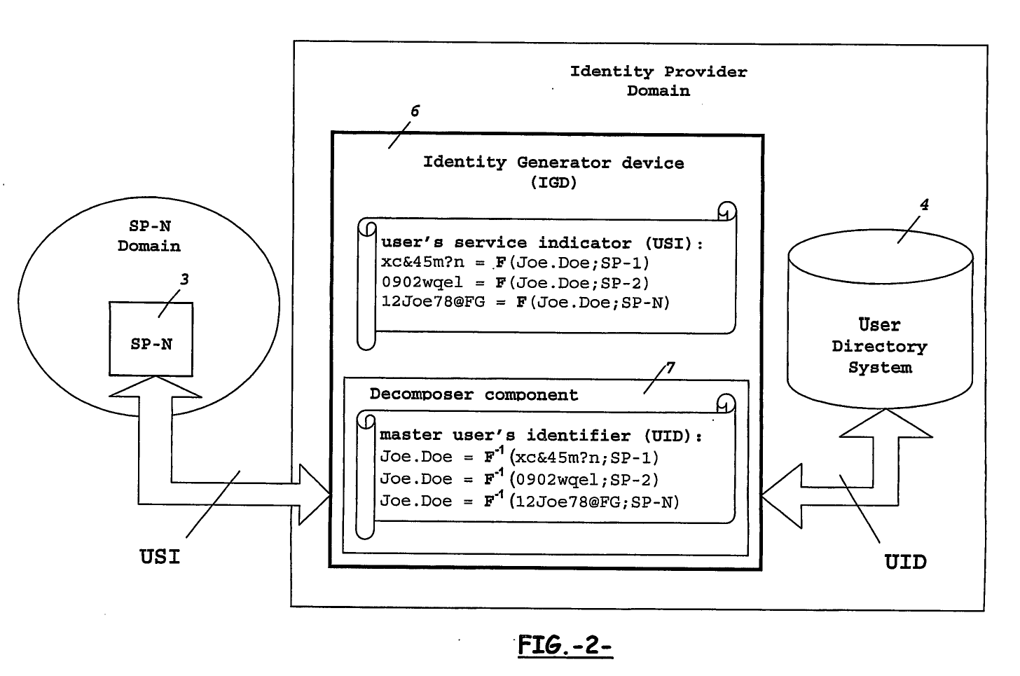

In accordance with a first aspect of the invention, there is provided an Identity Generator device (6) illustrated in FIG. 2 and arranged to generate a same alias (12Joe78@FG) for the user (5) per service provider (3) during communication between two domains such as the case of a service provider (SP-N) and an identity provider (IDP). This alias is named user's service indicator (USI) in the instant specification.

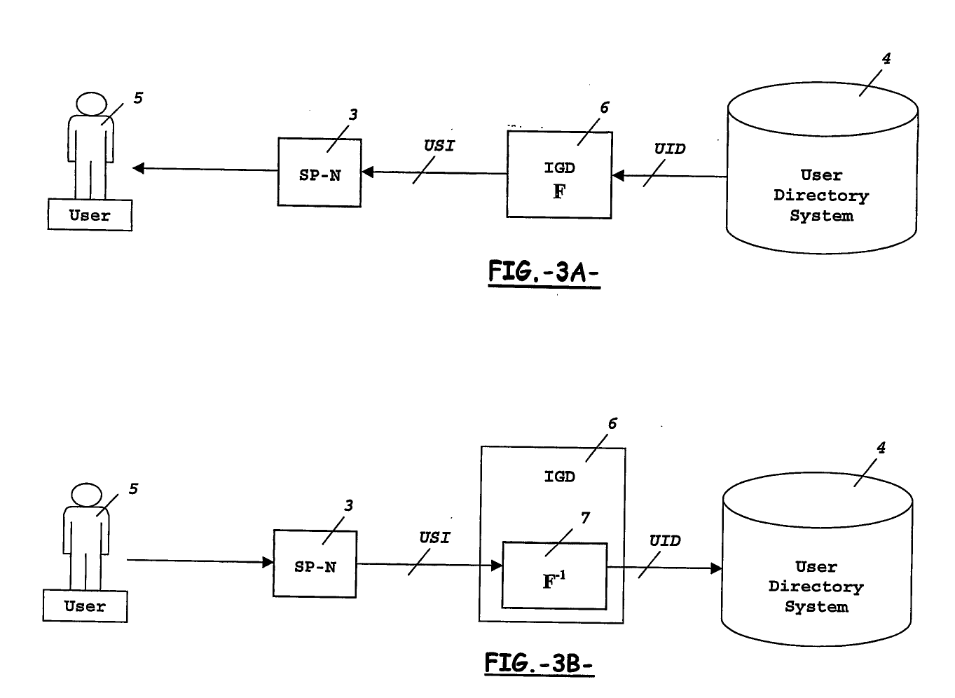

Therefore, in a first embodiment of the present invention illustrated in FIG. 2 and FIG. 3A, this user's service indicator (USI) is generated as a function (F) of a master user's identifier (UID) (Joe.Doe) at the identity provider, and a service provider (SP-N) indicator (SPI).

Generally speaking, an explicit user's identity should not be used in the user's alias generation to avoid that the service provider might deduct or make use of such explicit user's identity. Hence, the user is assigned a master user's identifier (UID) at the identity provider that is opaque and cannot be understood by third parties, the identity provider being in particular a network operator.

The user's service indicator (USI) is a shared key to identify the user at both service provider and operator's network. Upon reception of any communication at an entity of the network operator from the service provider based on said user's service indicator (USI) (12Joe78@FG), this entity (7) of network operator is enabled to carry out a reverse generation (F⁻¹) to obtain the corresponding master user's identifier (UID) (Joe.Doe) as FIG. 3B along with FIG. 2 illustrate.

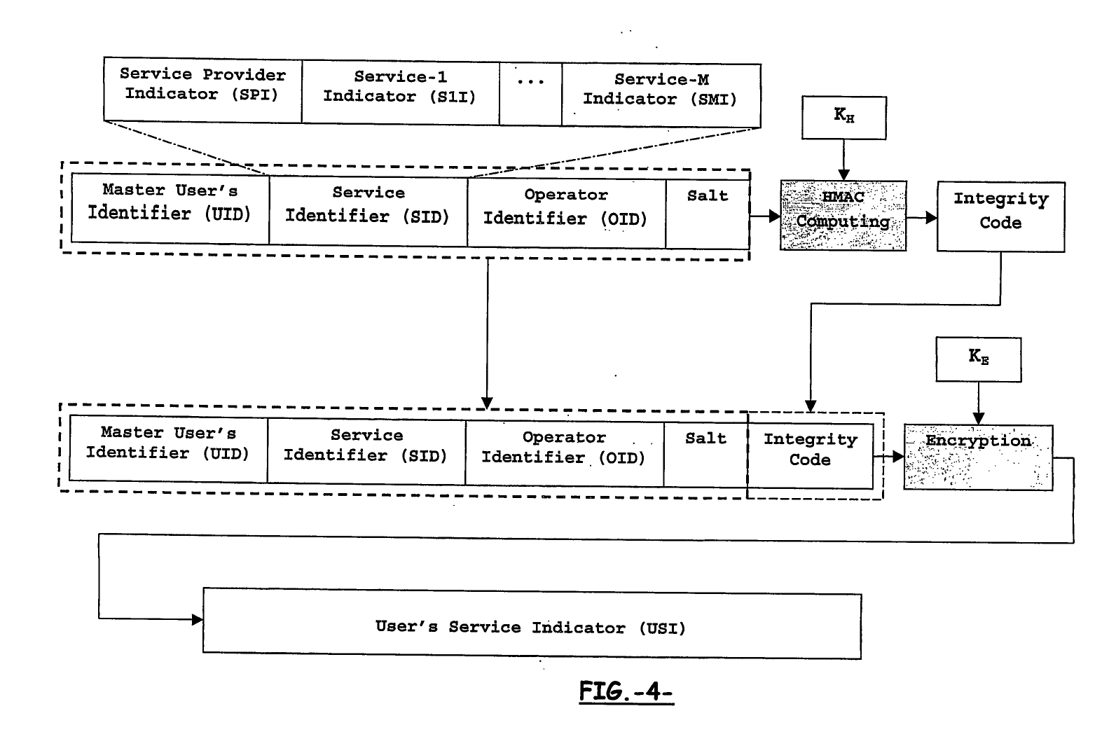

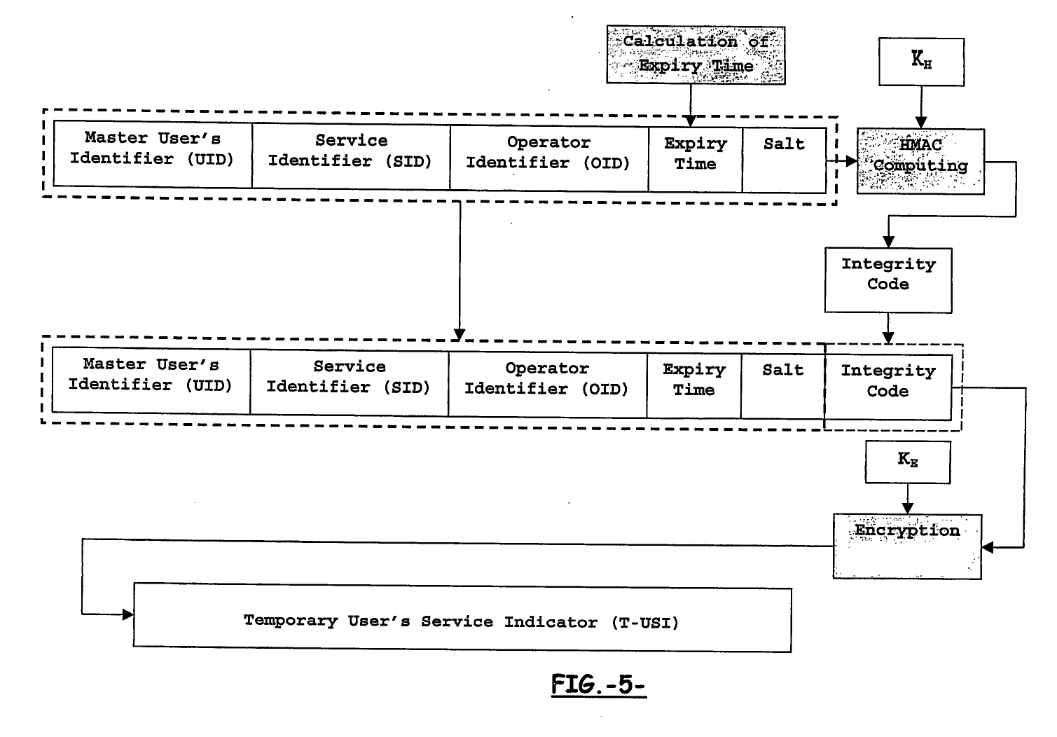

Therefore, in accordance with an advantageous embodiment, a generation (F) function makes use of a symmetric cipher and a ciphering key (K_{E}) further shown in FIG. 4 and FIG. 5. In this respect, there are two possibilities to generate and use the ciphering key (K_{E}): the key is unique in the whole system and used to encrypt all identities for all the service providers, or the key is different per service provider.

From a security point of view, it is better to use different keys, one for each service provider, because the reuse of the same key very often can lead to potential attacks. This implies, however, that in every request from a service provider using an alias, the identity of the service provider is made always known. Otherwise, if the identity of the service provider is not known in all the requests, a unique key may be used for the whole system, or a default key is used for those unknown service providers. To this end, the ciphering key (K_{E}) used to generate the user's service indicator (USI) at the Identity Generator device (6) during the process presented in FIG. 3A is also available during the process illustrated in FIG. 3B where a reverse generation (F⁻¹) takes place to obtain the corresponding master user's identifier (UID). This is one of the reasons why the reverse generation (F⁻¹) feature (7) is preferably placed in the Identity Generator device (6) as shown if FIG. 3B, though said reverse generation (F⁻¹) feature (7) might as well be placed in, or in co-operation with, another network entity such as a Border Gateway, not illustrated in any drawing, acting as entry point for service providers to the operator's domain and generally placed at the border of the operator domain.

In an advantageous embodiment of the present invention, the above master user's identifier (UID) may be derived from an explicit user's identity, in order to add additional entropy to the generation function (F). For example, the master user's identifier (UID) could be a one way hash value (SHA-1) of a real user identity such as the Mobile Station ISDN Number (MSISDN):
Seed=SHA-1(MSISDN);

The result may produce a 160 bits output that can be used to derive a master user's identifier truncated to a desired number of bits:
UID=First_{—}64_bits (Seed);

The exemplary use of a 64-bit code for the master user's identifier (UID) is actually a compromise between enough address space for identities, and not too much size for storage, since this master user's identifier (UID) is stored as one of the identities of the user and can be used as a search key in a user directory (4) accessible to the operator's network. That is, the identity provider (IDP), which in particular may be a network operator, uses this master user's identifier as a search key when performing any lookup for the user in the user directory system.

Thus, the Identity Generator device is preferably provided according to an embodiment of the invention with a Decomposer component (7) having the means to carry out a reverse generation (F⁻¹) from the user's service indicator (USI) to obtain the corresponding master user's identifier (UID):
UID+SPI=F⁻¹(USI, key)

In accordance with another embodiment of the invention, this Decomposer component (7) is separable from the Identity Generator device (6) for being integrated in, or used in co-operation with, other entities at the identity provider (IDP) domain or at the service provider (SP) domain. Therefore, the Decomposer component (7) is provided with means for obtaining the same or corresponding ciphering key (K_{E}) per service provider or per service application as the one used to generate a user's service indicator at the Identity Generator device. Nevertheless, when the Decomposer component (7) is integrated in the Identity Generator device (6), they both may share the means for obtaining a ciphering key (K_{E}).

In accordance with a second aspect of the present invention, there is provided an Identity Generator device (6) arranged to generate a user's service indicator (USI) following a structured pattern that includes a permanent user alias, such as the above master user's identifier, an indicator of the services to be accessed at a service provider, and possibly a number of additional fields to fit additional requirements and guarantee the strength and security of the solution.

Thus, in a currently preferred embodiment of the present invention, there is provided an Identity Generator device (6) arranged to generate a permanent or temporary user's service indicator (USI) as those exemplary illustrated in FIG. 4 and FIG. 5 respectively.

FIG. 4 shows a structured pattern followed to build up a user's service indicator (USI) to be shared by a service provider (SP-1; SP-2; SP-N) domain and an Identity Provider (IDP) domain, and intended to identify the user in both said domains.

The structured pattern in FIG. 4 comprises a master user's identifier (UID), which is a permanent user alias so to say, and that may be an already existing user's identity such as the International Mobile Subscriber Identity (IMSI), or a Mobile Station ISDN Number (MSISDN), or a token created ad hoc, in particular a value from a one way hash function like in the first above embodiment, and preferably arranged to be used as an indexed identity to search user's profile data.

The structured pattern in FIG. 4 also comprises a service identifier (SID), indicative of services to be accessed at the service provider by the user. This service identifier (SID), as illustrated in FIG. 4, may just include a service provider indicator (SPI) as suggested in the first above embodiment, or may include a number of individual service indicators (S1I; SNI), or combinations thereof (SPI, S1I, SNI). That is, in this preferred second embodiment, a basic structured pattern to generate a user's service indicator comprises a master user's identifier and a service identifier, the former arranged to search user's profile data in the identity provider domain, and the latter including information indicative of services to be accessed at the service provider by the user.

For example, the service identifier (SID) may include a service provider indicator (SPI) alone to indicate that any service at the service provider can be accessed, or may include a service provider indicator (SPI) followed by a list of generic service indicators that, being applicable to a plurality a service providers, can be accessed at the given service provider. Also for example, the service identifier (SID) may only include a list of specific service indicators that, being just applicable to a given service provider, can be just accessed at the given service provider.

Moreover, the presence or non-presence of a service provider indicator (SPI) may depend on the way that external service providers access to the operator domain. Provided that the service provider is the entity that authenticates the operator's domain and access to its capabilities, the service identifier (SID) might preferably include the service provider indicator (SPI). However, provided that a service itself, or a service application, is the entity authenticating and directly accessing to the operator's capabilities, a service provider indicator (SPI) might not be needed whereas a number of service indicators (S1I; SNI) representing individual services, or service applications, might be more appropriate.

On the other hand, the present invention provides an additional benefit for access to user directory systems not having an access control feature based on the client that accesses said user directory system, such as the case may be in relational databases. Thus, the proposed solution makes it possible to include an indication of an entity (SID) for which the user's service indicator (USI) is generated.

A basic structured pattern as the above described comprising a master user's identifier (UID) and a service identifier (SID) may be considered the simplest user's service indicator (USI) in accordance with some embodiments of the invention.

Apart from the above master user's identifier (UID), which identifies the user at the identity provider domain, and the above service identifier (SID), which is indicative of services to be accessed by the user at the service provider, the structured pattern illustrated in FIG. 4 to build up a user's service indicator (USI) might advantageously include an operator identifier (OID). A possible advantage of including said operator identifier turns up in scenarios where there is a sort of federation or association of network operators in such a manner that a first network operator acts as identity provider and thus generates a user's service indicator (USI) whereas a second network operator is involved in the verification of any request from a given service provider based on said user's service indicator (USI) generated for said given service provider. In this context, the second network operator might need to reverse the received user's service indicator (USI) to obtain the master user's identifier (UID) identifying the user and the operator identifier (OID) indicating where such user's service indicator (USI) was generated.

For this and other purposes, there may be a Central Provisioning Entity (CPE) arranged with means to provide appropriate operator identifier (OID) codes, service identifier (SID) codes, and available ciphering key (K_{E}) values towards the Identity Generator device (6) and towards those other entities, such as Border Gateways, wherein a Decomposer component (7) may be integrated, or co-operating with, the Decomposer component (7) being in charge of applying a corresponding reverse generation (F⁻¹) function. More precisely, the Central Provisioning Entity (CPE) is arranged with means to provide operator identifier (OID) codes, service identifier (SID) codes, and available ciphering key (K_{E}) values towards the Identity Generator device (6) and towards the Decomposer component (7) when the latter is, or resides in, a different entity than the Identity Generator device (6).

For these and other purposes, the Decomposer component (7) is provided with means for obtaining same or corresponding operator identifier (OID) codes, service identifier (SID) codes, and available ciphering key (K_{E}) values as the ones used to generate the available user's service indicators (USI). That is, if no ciphering mechanism took place, there is no need for such ciphering key (K_{E})

Moreover, a user's service indicator (USI) might as well include an auxiliary generated value (Salt), as shown in FIG. 4 and FIG. 5, to allow the regeneration of identifiers that a user's service indicator (USI) might consist of, as well as to increase the entropy of the structure.

Further, and irrespective of whether the structured pattern comprises only basic fields such as master user's identifier (UID) and service identifier (SID), or also additional fields such as operator identifier (OID) and auxiliary values (Salt), an integrity code is computed as a function of this structured pattern and a certain key (K_{H}), by following construction rules of a Hashed Message Authentication Code (generally known as HMAC), for example. Then, this integrity code is appended to the structured pattern, and the resulting new structure is preferably encrypted with a symmetric algorithm along with an encryption key (K_{E}).

This new encrypted structure being considered an appropriate user's service indicator (USI), as illustrated in FIG. 4, for use in a wide range of entities and in different possible scenarios.

Apart from this sort of permanent user's identity, so to say, used for services with a user account introduced as background of the present invention, as the user's service indicator (USI) may be considered, the Identity Generator device (6) is also arranged to generate a temporary user's identity for services without a user account, which were also introduced in the background section.

In this respect, a temporary user's identity might be generated by simply adding an expiry time field to the structured pattern being used to build up a user's service indicator and shown in FIG. 4, the thus resulting new structure being considered a temporary user's service indicator (T-USI).

For example, FIG. 5 shows the construction of a temporary user's service indicator (T-USI) just differing from the user's service indicator (USI) shown in FIG. 4 on that the former includes an expiry time field. In a preferred embodiment like the one in FIG. 5, this expiry time field is included before computing the integrity code commented above, however, in other possible embodiments not shown in any drawing, the expiry time could be included further to facilitate the selection of an appropriate auxiliary generated value (Salt) and reverse generation function (F⁻¹) to allow the regeneration of identifiers. Nevertheless, its inclusion in the structured pattern before being encrypted is preferable from a security point of view, and in order to prevent any tampering.

In respect of expiry time calculations, different criteria may be taken into account on a per user and service basis. For instance, an applicable criterion might be the type of Service Level Agreement (generally known as SLA) established between the operator and the service provider for a specific service. Another applicable criterion might be the connection status of the user, wherein different expiry times may be established depending on whether the user is on or off line. A further applicable criterion might be the type of authentication performed for a user in an on line mode. A still further applicable criterion might be any other suitable policy decided by the operator.

From a use perspective, the Identity Generator device (IGD) (6) described hereinbefore is suitable for generating permanent and temporary user's identities, on a per service provider, on a per identity provider basis, and combinations thereof. This Identity Generator device (IGD), which might be implemented as a standalone entity or integrated in another domain entity, is suitable for use in an Identity Provider (IDP) domain to effectively reduce the needs for storage of huge amounts of user's search keys in said domain, thus accomplishing one object of the present invention.

For instance, the Identity Generator device (6) might be integrated with a Central Provisioning Entity (CPE) responsible for provisioning tasks in the identity provider domain, in particular the operator's network, in order to update a user directory system (4) and other enablers. Nevertheless, the Identity Generator device (6) might be integrated with the user directory system instead.

On the other hand, the Identity Generator device (6), or at least the Decomposer component (7) having the means (F⁻¹) for carrying out a reverse generation of the different identifiers included in a given user's service indicator (USI), might as well be integrated in a so-called Identity-based Proxy acting as a border gateway that is the only entry point for all those identity-based operations towards the user directory system (4). In this respect, this so-called Identity-based Proxy acting as a border gateway is preferably responsible for verifying a returned temporary user's service indicator (T-USI) for different purposes such as charging for an offered service.

This verification requires means (F⁻¹) for carrying out a reverse generation of the different identifiers that the user's service indicator (USI) includes and, thereby, the Identity Generator device (6), or rather the Decomposer component (7), integrated in or in co-operation with the so-called Identity-based Proxy, is preferably the entity responsible for this task. Therefore, the means for carrying out a reverse generation at this Decomposer component (7) preferably includes: means for obtaining applicable expiry time criteria; and means for verifying the validity of a given temporary user's service indicator (T-USI) against said expiry time criteria.

Moreover, this solution would somehow transfer a similar drawback to the service provider domains. In this respect, and in accordance with another aspect of the present invention, the Identity Generator device (6) is also suitable for use in a Service Provider (SP-1; SP-2; SP-N) domain to effectively reduce the needs for storage of huge amounts of user's search keys in said domain. Therefore, the service provider might create a structured pattern containing an own indexed identity and a sort of operator indicator, and likely other auxiliary indicators. The final shared identity to be exchanged between both Service Provider and Identity provider being a still new structure comprising the above user's service indicator (USI) generated at the identity provider and the structured pattern generated at the service provider without further encryption.

Applicant's invention is described above in connection with various embodiments that are intended to be illustrative and non-restrictive. It is expected that those of ordinary skill in this art may modify these embodiments. The scope of Applicant's invention is defined by the claims in conjunction with the description and drawings, and all modifications that fall within the scope of these claims are intended to be included therein.

1. An Identity Generator device arranged for generating a user's service indicator for a user to access a number of services offered by a service provider through a network operator where user data for the user are accessible, this user's service indicator being usable between the service provider domain and the network operator domain to unambiguously identify the user at each respective domain, the Identity Generator device comprising:
means for obtaining a master user's identifier usable to identify the user at the operator's network;
means for obtaining a service identifier, indicative of services to be accessed at the service provider; and
means for constructing a user's service indicator that includes the master user's identifier and the service identifier.

2. The Identity Generator device of claim 1, wherein the service identifier, indicative of services to be accessed at the service provider, comprises at least one element selected from: a service provider indicator, and a number of service indicators.

3. The Identity Generator device of claim 1, further comprising:
means for obtaining at least one element selected from: network operator identifier, auxiliary value, expiry time, and integrity code; and
means for including the at least one element into the user's service indicator.

4. The Identity Generator device of claim 1, wherein the master user's identifier is built up as a function of a real user identity.

5. The Identity Generator device of claim 1, further comprising means for carrying out a symmetric cipher of the user's service indicator using a ciphering key.

6. The Identity Generator device of claim 5, wherein the ciphering key is unique for all the applicable service providers.

7. The Identity Generator device of claim 5, wherein the ciphering key is different per each service provider.

8. The Identity Generator device of claim 1, further comprising a Decomposer component having means for carrying out a reverse generation to obtain a master user's identifier from a given user's service indicator.

9. A Decomposer component having means for carrying out a reverse generation to obtain a master user's identifier from a given user's service indicator, the Decomposer component arranged for integration in, or co-operation with, at least one entity selected from: the Identity Generator device and other entities at the identity provider domain or at the service provider domain.

10. The Decomposer component of claim 9, wherein the means for carrying out a reverse generation includes means for obtaining the service identifier used to generate the given user's service indicator.

11. The Decomposer component of claim 9, wherein the means for carrying out a reverse generation further comprises:
means for obtaining at least one element selected from: network operator identifier, and ciphering key used to generate the given user's service indicator.

12. The Decomposer component of claim 9, wherein the means for carrying out a reverse generation further comprises:
means for obtaining applicable expiry time criteria; and
means for verifying the validity of a given temporary user's service indicator against said expiry time criteria.

13. The Decomposer component of claim 9, further comprising means for verifying the validity of a given user's service indicator by making use of the master user's identifier as a search key towards a user directory system.

14. A method for generating a user's service indicator intended for a user to access a number of services offered by a service provider through a network operator where user data for the user are accessible, this user's service indicator being usable between the service provider domain and the network operator domain to unambiguously identify the user at each respective domain, the method comprising the steps of:
obtaining a master user's identifier usable to identify the user at the operator's network;
obtaining a service identifier, indicative of services to be accessed at the service provider, and
constructing a user's service indicator that includes the master user's identifier and the service identifier.

15. The method of claim 14, wherein the step of obtaining a service identifier includes obtaining at least one element selected from: a service provider indicator, and a number of service indicators.

16. The method of claim 14, further comprising:
obtaining at least one element selected from: network operator identifier, auxiliary value, expiry time, and integrity code; and
including the at least one element into the user's service indicator.

17. The method of claim 14, wherein the step of obtaining a master user's identifier includes a step of applying a function to a real user identity.

18. The method of claim 14, further comprising carrying out a symmetric cipher of the user's service indicator using a ciphering key.

19. The method of claim 18, wherein the ciphering key is unique for all the applicable service providers.

20. The method of claim 18, wherein the ciphering key is different per each service provider.

21. The method of claim 20, further comprising determining a service provider issuing a communication based on a given user's service indicator.

22. The method of claim 14, further comprising carrying out a reverse generation to obtain the master user's identifier from a given user's service indicator.

23. An Identity Generator device for generating a user's service indicator for a user to access a number of services offered by a service provider through a network operator where user data for the user are accessible, this user's service indicator being usable between the service provider domain and the network operator domain to unambiguously identify the user at each respective domain, the Identity Generator device comprising:
means for obtaining a master user's identifier usable to identify the user at the operator's network;
means for obtaining a service identifier, indicative of services to be accessed at the service provider; and
means for constructing a user's service indicator that includes the master user's identifier and the service identifier, wherein said Identity Generator device is integrated in, or in close cooperation with, and entity of an identity provider network.

24. The Identity Generator device use of claim 23, wherein the identity provider network is an operator's network where the user data are accessible.

25. The Identity Generator device use of claim 24, wherein the entity is a Central Provisioning Entity responsible for provisioning tasks in the operator's network.

26. The Identity Generator device of claim 24, wherein the entity is a User Directory System storing user data.

27. The Identity Generator device of claim 24, wherein the entity is a Border Gateway placed at the border of the operator domain.

28. The Identity Generator device of claim 27, wherein the Border Gateway is an entity selected from: an HTTP Proxy, a WAP Gateway, and a Messaging Gateway.

29. (canceled)
